(19) United States
(12) Patent Application Publication
(10) Pub. No.: US 2015/0155700 A1
(43) Pub. Date: Jun. 4, 2015

(54) METHOD AND APPARATUS FOR SHORT CIRCUIT PROTECTION OF POWER SEMICONDUCTOR SWITCH

(71) Applicant: ABB Oy, Helsinki (FI)

(72) Inventors: Rodrigo Alonso ALVAREZ VALENZUELA, Nurnberg (DE); Ignacio Lizama, Dresden (DE); Steffen Bernet, Dresden (DE); Matti Laitinen, Kirkkonummi (FI)

(73) Assignee: ABB OY, Helsinki (FI)

(21) Appl. No.: 14/559,222

(22) Filed: Dec. 3, 2014

(30) Foreign Application Priority Data
Dec. 4, 2013 (EP) 13195668.2

(51) Int. Cl. H02H 3/08

(52) U.S. Cl. CPC H02H 3/08

(57) ABSTRACT

A method and apparatus are provided for a power semiconductor switch. A current through the switch is responsive to a control terminal voltage at a control terminal of the switch, and the control terminal voltage is driven by a driver unit. The method includes measuring or estimating the current based on a bond voltage of the switch, detecting a short circuit by comparing the measured or estimated current to a short circuit current limit, controlling an on-state voltage level of the control terminal voltage based on the comparison to limit the current through the switch during the short circuit, and controlling the control terminal voltage to an off-state voltage level to turn the switch off. The on-state voltage level voltage is controlled by pulse-width modulating the output of the driver unit. A switching frequency of the modulation is at least the cut-off frequency of low-pass characteristics of the control terminal.

### RELATED APPLICATION

This application claims priority to European Application 13195668.2 filed in Europe on Dec. 4, 2013. The entire contents of this application are hereby incorporated by reference in their entirety.

### FIELD

The present disclosure relates to short circuit protection of power semiconductor switches.

### BACKGROUND INFORMATION

Power converters are used in a wide variety of applications. A power converter may include one or more semiconductor switches which are used to convert power from one form to another. For example, a DC voltage can be converted to an AC voltage or voltages.

In order to perform the conversion, each of the switches in a power converter may be controlled into one of two states: an on-state (i.e. a conductive state) and an off-state (i.e. a non-conductive state). Therefore, turning a switch on means, in this context, setting the switch to the on-state. Accordingly, turning a switch off means setting the switch to the off-state.

Applications using electrical power converters, particularly high-power applications, may require high operating reliability. Therefore, fault protection of the semiconductors in a power converter can be an important part of the converter protection scheme. A fault protection can be required to avoid destruction of the semiconductors in a short circuit situation and to improve the reliability of the converter.

Various short circuit detection schemes have been developed for protecting power electronic switches, such as insulated-gate bipolar transistors (IGBTs). For example, a short circuit can be detected by measuring of the collector-emitter saturation voltage V_{CE,SAT} of the switch [see references 1, 2]. However, the measurement of the V_{CE,SAT} requires a settling time which can increase the response time of the short circuit protection system. Turning off the short circuit current can take about 10 μs, for example. Such a delay can cause an abrupt rise in the junction temperature of the switch. The temperature can rise by about 50° C. in a short period of time, for example. This can cause high mechanical stress in the semiconductor, which can even cause the switch to explode. A possibility of such an uncontrolled failure naturally reduces the reliability of the converter.

In order to achieve a faster response to a short circuit, the semiconductor can be turned off immediately after the short circuit is detected, that is, before a stable state of the semiconductor is achieved. The short circuit can be detected by measuring the current through the switch with a Rogowski coil [see reference 3], for example. However, turning off the semiconductor before the stable state is achieved can also generate stress and induce even destruction of the device.

Short circuit protection can be based on monitoring or controlling the rate of change di/dt of the current through the switch [see references 4, 5]. For example, an abnormal rate of change di/dt can be used as an indicator of a possible short circuit. If a possible short circuit is detected, the control electrode of the switch can be de-charged in order to reduce the current through the switch. If other criteria confirming the short circuit are detected, the switch is turned off. By using this approach, the increase in the current due to a short circuit can be limited. On the other hand, the control electrode can be unnecessarily de-charged even if there is no short circuit. This can increase losses during normal operation.

Implementation of any of the above-mentioned approaches can cause additional expenses in material, development and manufacturing costs, making service more complicated and difficult.

### SUMMARY

An exemplary embodiment of the present disclosure provides a method for a power semiconductor switch. A current through the switch is responsive to a control terminal voltage at a control terminal of the switch. The control terminal voltage is driven by a driver unit. The exemplary method includes measuring or estimating the current, and detecting a short circuit by comparing the measured or estimated current to a short circuit current limit. The exemplary method also includes controlling an on-state voltage level of the control terminal voltage on the basis of the comparison to limit the current through the switch during the detected short circuit. The on-state voltage level voltage is controlled by pulse-width modulating the output of the driver unit. A switching frequency of the modulation is at least the cut-off frequency of low-pass characteristics of the control terminal. In addition, the method includes controlling the control terminal voltage to an off-state voltage level in order to turn the switch off.

An exemplary embodiment of the present disclosure provides an apparatus for a power semiconductor switch. A current through the switch is responsive to a control terminal voltage at a control terminal of the switch. The control terminal voltage is driven by a driver unit. The exemplary apparatus includes means for measuring or estimating the current, and means for detecting a short circuit by comparing the measured or estimated current to a short circuit current limit. The exemplary apparatus also includes means for controlling an on-state voltage level of the control terminal voltage on the basis of the comparison to limit the current through the switch during the detected short circuit. The means for controlling the on-state voltage are configured to control the on-state voltage level voltage by pulse width modulating the output of the driver unit. A switching frequency of the modulation is at least the cut-off frequency of low-pass characteristics of the control terminal. In addition, the exemplary apparatus includes means for controlling the control terminal voltage to an off-state voltage level in order to turn the switch off.

An exemplary embodiment of the present disclosure provides a non-transitory computer-readable recording medium having a computer program tangibly recorded thereon that, when executed by a processor of a computer processing device, causes the processor to carry out a method for a power semiconductor switch communicatively coupled to the power semiconductor switch. A current through the switch is responsive to a control terminal voltage at a control terminal of the switch. The control terminal voltage is driven by a driver unit. The exemplary method includes measuring or estimating the current, and detecting a short circuit by comparing the measured or estimated current to a short circuit current limit. The exemplary method also includes controlling an on-state voltage level of the control terminal voltage on the basis of the comparison to limit the current through the switch during the detected short circuit. The on-state voltage level voltage is controlled by pulse-width modulating the output of the driver unit. A switching frequency of the modulation is at least the cut-off frequency of low-pass characteristics of the control terminal. In addition, the method includes controlling the control terminal voltage to an off-state voltage level in order to turn the switch off.

### BRIEF DESCRIPTION OF THE DRAWINGS

Additional refinements, advantages and features of the present disclosure are described in more detail below with reference to exemplary embodiments illustrated in the drawings, in which:

FIG. 1 is a simplified block diagram of an exemplary implementation of the method according to the present disclosure;

FIG. 2 shows a simplified model of an IGBT;

FIGS. 3a to 3c show exemplary waveforms of estimating collector current i_{C} by comparing a bond voltage V_{bond} with a threshold voltage V_{ref};

FIG. 4 shows a simplified exemplary embodiment of a current measurement based on estimation through comparison;

FIG. 5 shows a simplified flow diagram for an exemplary short circuit detection scheme able to distinguish different short circuit scenarios;

FIGS. 6a to 6c show simplified flow diagrams of exemplary responses to different types of short circuits;

FIG. 7 shows an exemplary implementation of a power stage suitable for a driver unit of FIG. 1;

FIG. 8 shows exemplary waveforms of the power stage of FIG. 7 during a short circuit;

FIG. 9 shows a simplified presentation of an exemplary embodiment of the method in a frequency converter; and

FIGS. 10a to 10e show exemplary test results for the method of the present disclosure.

### DETAILED DESCRIPTION

Exemplary embodiments of the present disclosure provide a method and an apparatus for implementing the method which alleviate the above disadvantages associated with known techniques. Exemplary embodiments of the present disclosure provide a method and an apparatus for a power semiconductor switch, where a current through the switch is responsive to a control terminal voltage at a control terminal of the switch, and the control terminal voltage is driven by a driver unit. Exemplary features of the method and apparatus of the present disclosure are described below.

The method and apparatus of the present disclosure each achieve an object of providing short circuit protection for a power semiconductor switch (e.g., IGBT, MOSFET, etc.). According to an exemplary embodiment, the method can include steps of detecting a short circuit of a power semiconductor switch, reducing the maximum level of a control terminal voltage (e.g., a gate-emitter voltage in IGBT) in order to limit the short circuit current and accelerate the desaturation of the switch, and then turning off the short circuit current. The short circuit can be detected by direct or indirect current estimation. The indirect estimation of the current can be based on measuring the bond voltage, for example. The maximum level of the control terminal voltage can be reduced by modulating an output of a driver unit driving the control terminal voltage at a high frequency.

The method of the present disclosure enables fast detection and turn-off of the short circuit current, thus, limiting the energy involved in the short circuit. This minimizes the risk of a mechanical damage in the switch during a short circuit, thus enabling savings in cost and service time. The method does not require current sensors for detecting the short circuit and allows effective limitation and fast turn-off of the short circuit current. The method causes no additional losses during normal operation. In fact, the method allows reduction in the on-state conduction losses during normal operation by allowing increase of the gate-emitter voltage in normal operation.

Exemplary embodiments of the present disclosure provide a short circuit protection method for a power semiconductor switch, where a current through the switch is responsive to a control terminal voltage at a control terminal of the switch. The control terminal voltage can be driven by a driver unit. For example, the control terminal voltage can be gate-emitter voltage of an IGBT or a MOSFET, and the control terminal can be the gate switch. The driver unit can then be a gate driver unit.

Further, the present disclosure provides an apparatus implementing the method.

The method can include detecting a short circuit with an indirect current estimation. For example, the current can be estimated on the basis of a bond voltage, for example, a voltage over a stray inductance formed by a chip bonding of the switch. The short circuit can be detected by comparing the estimated current to a short circuit current limit.

The control terminal voltage can then be controlled on the basis of the comparison. By adjusting the on-state voltage level of the control terminal voltage, the short circuit current can be limited and desaturation of the switch accelerated. After the desaturation has been reached, the switch can be turned off.

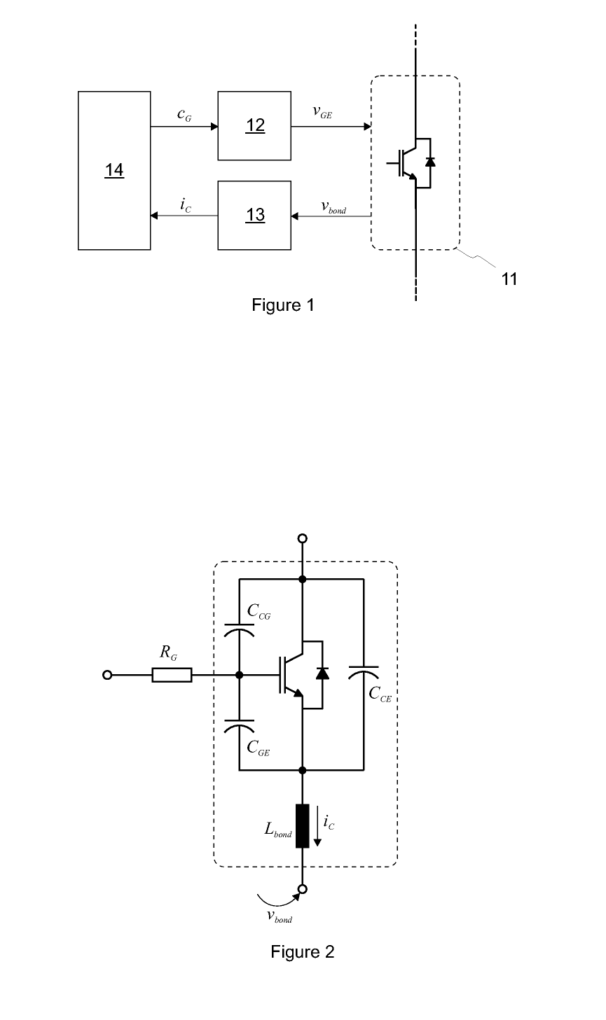

FIG. 1 is a simplified block diagram of an exemplary implementation of the method according to the present disclosure. A power semiconductor switch 11 in the form of an IGBT is controlled by a driver unit 12 in the example of FIG. 1. The driver unit 12 drives the control terminal voltage, which in this case is the gate-emitter voltage V_{GE}, of the switch 11. The driver unit 12 is controlled by a controller 14. The controller 14 can also control the switch 11 during normal operation. Normal operation in this context means operation under operating conditions where a short circuit has not been detected. For example, the controller 14 can control the power conversion by controlling turn-ons and turn-offs of the switches in the converter. The controller 14 can be an FPGA on a frequency converter, for example.

A current sensing unit 13 estimates or measures a current through the switch 11. For example, the current sensing unit 13 can estimate the collector current i_{C} of the switch 11 by measuring a voltage over an inductance in series with the switch. The voltage over the inductance can be a bond voltage V_{bond}, for example. The current sensing unit 13 can estimate the current i_{C} by comparing the measured voltage with a predetermined limit and by measuring the time the bond voltage V_{bond} exceeds the limit. The time can then be used for estimating the current i_{C}.

In FIG. 1, a representation of the estimated current is transmitted to the controller 14 which compares it with a short circuit current limit in order to determine if a short circuit has occurred. The controller 14 then controls the control terminal voltage, at the control terminal (in this case, the gate) of the switch 11 on the basis of the comparison.

For example, in case of a short circuit, the controller 14 can control the switch 11 directly to off-state. Alternatively, the controller 14 can first desaturate the switch 11 by adjusting the on-state control terminal voltage level. The on-state control terminal voltage can be reduced to a level which limits the current but still exceeds the threshold voltage of the switch. After the switch 11 has been desaturated, the switch can be turned off 11.

Even though the block diagram in FIG. 1 shows only one switch, the method is easily applicable to a plurality of switches. The fast detection and turn-off of the switch in the method of the present disclosure reduces the energy involved in case of a failure, limiting the temperature rise in semiconductor switches during the failure and avoiding mechanical destruction of the semiconductor switches.

Various aspects of the method of the present disclosure are now discussed in more detail.

A robust estimation of current can be based on measuring the bond voltage v_{bond} across a bonding inductance L_{bond}. FIG. 2 shows a simplified model of an IGBT. The model shows an internal gate-emitter capacitance C_{GE}, collector-gate capacitance C_{CG}, and collector-emitter capacitance C_{CE}. The model further shows an internal stray capacitance L_{bond} which can represent a chip bonding between the emitter on the IGBT chip and an external emitter terminal of the IGBT module, for example. The model also shows a gate resistance R_{G} connected to the gate of the IGBT.

The bond voltage V_{bond} is proportional to the slope of the collector current i_{C} in the following manner:

$${L}_{bond} \frac{d {i}_{C}}{d t} = {v}_{bond} . \qquad ( 1 )$$

In order to detect a short circuit, the bond voltage v_{bond} can be compared with a set threshold limit, thereby generating a digital pulse-like signal where the pulse represents the period the threshold limit is being exceeded. The length of this period is proportional to the value of the collector current i_{C}.

The time the bond voltage exceeds the set limit can be measured, and the current can be estimated on the basis of the measured time. If variation of the internal parameters of the IGBTs can be assumed to be within a set range, such as less than 10%, the current estimation is sufficiently accurate for the detection of a short circuit. This allows an extremely simple and fast estimation of the current for the short circuit detection.

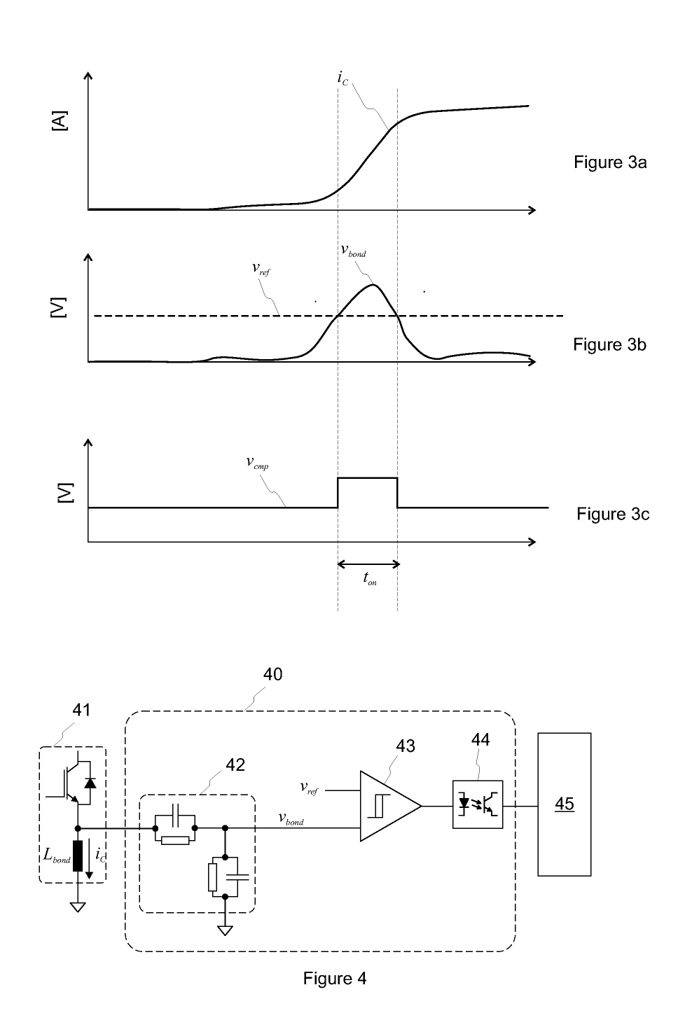

FIGS. 3a to 3c show exemplary waveforms of estimating collector current i_{C} by comparing a bond voltage V_{bond} with a threshold voltage v_{ref}. During the turn-on transient, the collector current i_{C} rises in FIG. 3a. The bond voltage V_{bond} in FIG. 3b follows the rate of change (slope) of the collector current i_{C}. The bond voltage V_{bond} is compared with the threshold voltage v_{ref}. The voltage v_{cmp} in FIG. 3c represents the output of the comparison. When the bond voltage V_{bond} exceeds the reference voltage V_{ref}, the voltage v_{cmp} is set to a high voltage level. Otherwise, the voltage v_{cmp} is at a low voltage level. Thus, voltage v_{cmp} forms a pulse-shaped signal. The length tₒₙ of the pulse is proportional to the collector current i_{C} and can be used to estimate the present collector current i_{C}.

FIG. 4 shows a simplified exemplary embodiment of a current measurement 40 based on estimation through comparison. The bond voltage V_{bond} of a switch 41 is sensed by using a compensated voltage divider 42. A comparator 43 compares the sensed voltage V_{bond} with a small reference value v_{ref}. The comparator output 43 forms a digital pulse-shaped signal which indicates when the rate of change of the collector current i_{C} of the switch 41 exceeds the reference value. The length of the pulse can be used to approximate the collector current i_{C}.

In FIG. 4, the digital signal is transmitted to a controller 45 through an optical isolator 44 which provides a galvanic isolation. The controller 45 evaluates the duration of the pulse in order to detect a short circuit. The controller 45 can compare the duration of the pulse with a time limit corresponding with a desired collector current limit, for example.

The above-described current estimation approach is able to distinguish between different types of short circuits. For example, it is possible to distinguish a short circuit of type I, where the IGBT is turned on into a short circuit, from a short circuit of type II, where the short circuit occurs during the IGBT is already in the on-state. This allows the use of different time/current limits for the different short circuit types.

If information about the conduction state of the switch or switches is available, for example, from a controller of a frequency converter, the information can be used for classifying short circuits into certain short circuit types, which allows the use of different time/current limits. Use of an optimal current limit for a certain short circuit type (for example, the short circuit type II having a lower limit than the short circuit type I) allows even faster short circuit detection.

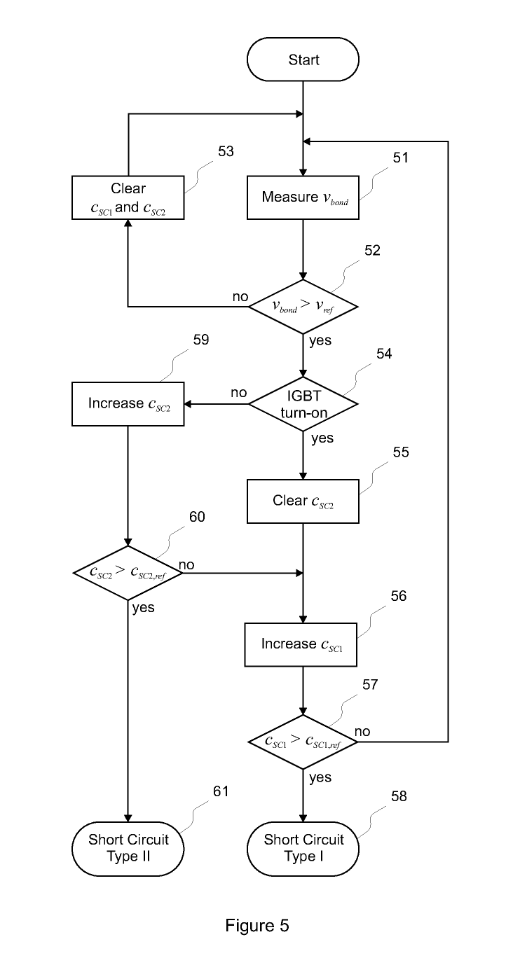

FIG. 5 shows a simplified flow diagram for an exemplary short circuit detection scheme for distinguishing the short circuit scenarios of type I from scenarios of II. Each short circuit type can have its own counter which represents a short circuit current. The short circuit current is compared with a limit in order to check if a short circuit condition for the short circuit type in question has been fulfilled. In FIG. 5, a counter c_{SC1} represents the short circuit type I and a counter c_{SC2} represents type II. The counters c_{SC1} and c_{SC2} have their own reference limits c_{SC1,ref} and C_{SC2,ref}, respectively.

In FIG. 5, the bond voltage V_{bond} is first measured in step 51 and then compared with a reference level v_{ref} in step 52. If the reference level v_{ref} is not exceeded, both counters are clear to zero value in step 53 and the method starts from the first step 51.

If the limit v_{ref} is exceeded, the method proceeds to step 54 where the conduction state of the switch, in this case IGBT, is checked. If the IGBT is being turned on or has just been turned on (for example IGBT in on-state for less than 2 μs), the method proceeds to step 55 in which the counter c_{SC2} of the short circuit type II is cleared as the short circuit is not of this type. The method then moves to step 56 where the counter c_{SC1} of the short circuit type I is increased. In the next step 57, the counter c_{SC1} compared with its reference limit C_{SC1,ref}, and if the limit C_{SC1,ref} is exceeded, a short circuit of type I is indicated in step 58. If the limit c_{SC1,ref} is not exceeded, the method returns to step 51.

However, if the IGBT is already on in step 54, the method proceeds to step 59, which increases the counter c_{SC2} of the short circuit type II. Then, in step 60, the counter is compared with its reference limit c_{SC2,ref}. If the limit is exceeded, a short circuit of type II is detected in step 61. If the limit is not exceeded, the method proceeds to step 56, and proceeds as described in the previous paragraph.

During a turn-on event, short circuits (of type I) can be detected by comparing the current to a limit which is proportional to a highest allowable current of the switch (for example the current rating of the switch).

However, the current cannot be expected to rise quickly during the stable on-state. Therefore, the reference limit for the short circuit type II can be much lower than the reference limit for the short circuit type I. In this manner, short circuits during on-state of the switch, i.e. short circuits of type II, can be detected faster.

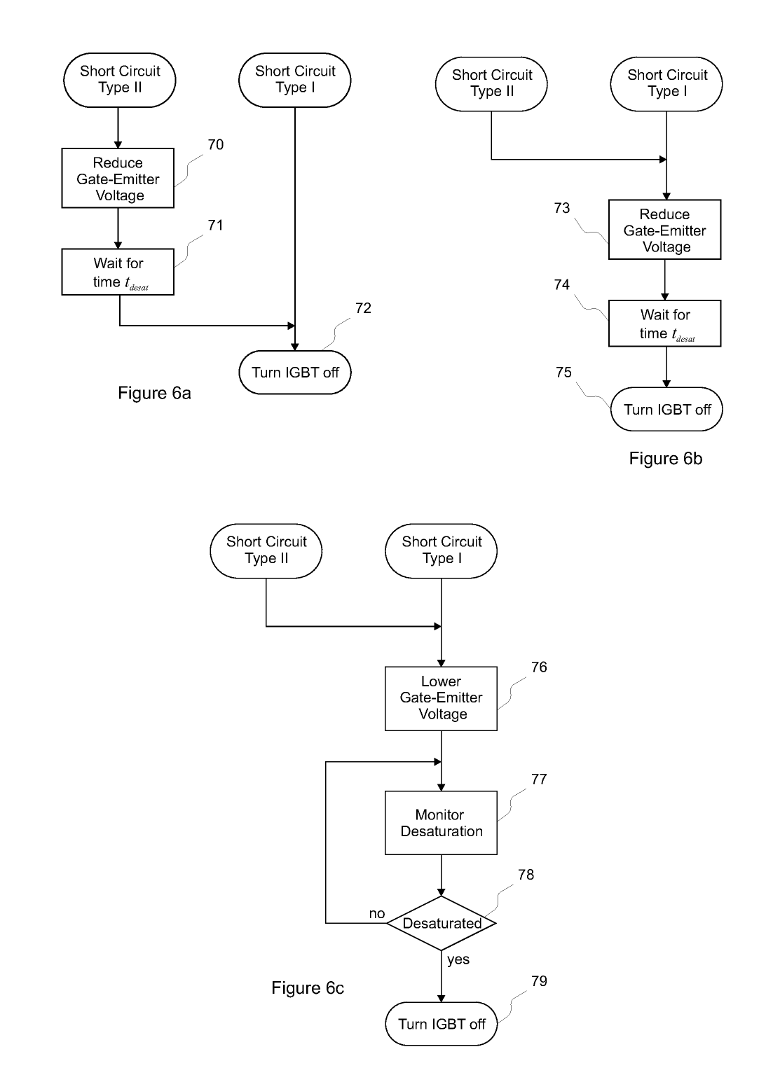

Actions after the detection of the short circuit can vary depending on the type of the short circuit. FIGS. 6a to 6c show simplified flow diagrams of exemplary responses to different types of short circuits.

In case of a short circuit type I of an IGBT, the IGBT can be turned off immediately after the detected short circuit before the IGBT saturates. FIG. 6a shows such an approach.

In order to limit the current through a saturated switch and/or ensure desaturation of the switch, the on-state voltage level of the control terminal voltage of a power semiconductor switch can be controlled based on the short circuit. For example, in case of a short circuit type II in FIG. 6a, the control terminal voltage, in the form of the gate-emitter voltage V_{GE} of the IGBT, is first reduced in step 70 to a value exceeding the threshold voltage of the IGBT in order to generate a faster desaturation of the IGBT and limit the current. After a predetermined time (e.g., 3 μs) from a detected short circuit, the control terminal voltage can be controlled to the off-state voltage level in order to turn the switch off. Step 72 of FIG. 6a shows turning off the IGBT after being held at a lowered on-state voltage level for a time t_{desat} in step 71.

Instead of turning the switch instantly off in a short circuit of type I, as shown in FIG. 6a, the control terminal voltage can be reduced the same way as in the case of the short circuit type II. For example, FIG. 6b shows a flow diagram where both short circuit types I and II are followed by a step 73 of using a reduced gate-emitter voltage V_{GE}. After waiting a time t_{desat} in step 74, the IGBT is turned off in step 75.

In embodiments where the desaturation of the switch can be detected, the control terminal voltage can be controlled to an off-state voltage level after desaturation has been detected. FIG. 6c shows a simplified flow diagram of short circuit protection using desaturation detection. After the detection of a short circuit (of either type), the gate-emitter voltage V_{GE} is reduced in step 76. Then, in step 77, desaturation is monitored. The desaturation can be monitored by using of one of known desaturation detection methods, for example. If desaturation is detected in step 78, the IGBT is turned off in step 79. If not, the method continues by monitoring desaturation again in step 77. In order to ensure that the IGBT is turned off at some point, the method can move to step 79 after a set maximum time even if desaturation has not been detected.

High dynamics for the control of the control terminal voltage can be achieved by utilizing structural features of the switch. Internal capacitances of a switch can be utilized to generate low-pass characteristics at the control terminal of the switching device. If the output of a driver unit driving the control terminal voltage is capable of providing a pulse-width-modulated signal at a high frequency, the reduction of the control terminal voltage can be achieved by pulse-width modulating the output of the driver unit at a switching frequency which is at least the cut-off frequency of the low-pass characteristics of the control terminal. The low-pass characteristics filter the pulse-width-modulated driver unit output signal into an essentially DC voltage.

For example, capacitances present at the gate together with the gate resistance complete an RC low-pass filter in the model of FIG. 2. The gate resistance and the internal gate-emitter capacitance C_{GE} form the low-pass filter up to the threshold voltage of the switch. For voltages above the threshold voltage, the collector-gate capacitance C_{CG} also affects the cut-off low-pass characteristics. Thus, the cut-off frequency of the filter depends on the capacitances C_{GE} and C_{CG} and the gate resistance. The cut-off frequency can be in the range of 0.5 to 5 MHz, for example. The gate-emitter voltage of the IGBT in FIG. 2 can be controlled with very high dynamics when the driver unit output driving the gate-emitter voltage is pulse-width modulated at a high frequency. The switching frequency of the PWM the driver unit can be such that the low-pass characteristics at the gate of the IGBT filter the driver unit output into a signal that is essentially a DC voltage which can have its voltage level below the on-state voltage level of the gate-emitter voltage during normal operation.

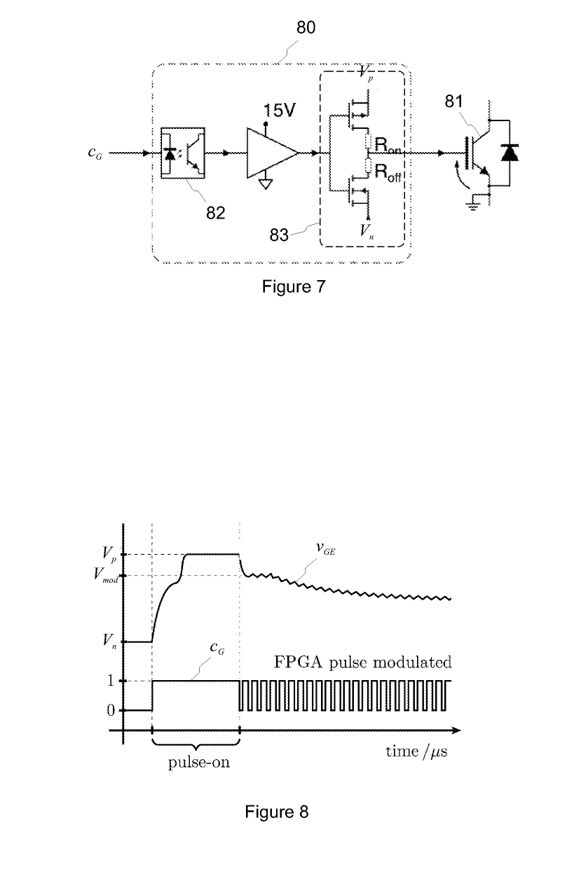

FIG. 7 shows an exemplary implementation of a power stage 80 which can be used to drive the gate-emitter voltage V_{GE} of a switch 81 which is an IGBT in FIG. 7. The power stage 80 can include a buffer circuit 82 which is controlled by a control signal C_{G} through an optical isolator 82. The output of the buffer 82 is converted to IGBT gate voltage levels by using a push-pull output circuit 83. The supply voltages Vₚ and Vₙ of the push-pull circuit 83 are generated by a supply unit not shown in FIG. 7.

The power stage 80 is able to generate a PWM signal at a high frequency, such as 5 MHz. This PWM signal is filtered by the IGBT 81, and forms a gate-emitter voltage V_{GE}.

FIG. 8 shows exemplary waveforms of the power stage of FIG. 7 during a short circuit. During a turn-on event at instant t₁, the control signal C_{G} controls the output of the push-pull circuit 83 to on-state as part of normal operation. The gate-emitter voltage V_{GE} is driven to the positive supply voltage Vₚ.

However, at instant t₂, the short circuit is detected in FIG. 8. The gate control signal c_{G} starts to modulate. As a result, the output of the push-pull circuit 83 switches between the positive supply voltage Vₚ and the negative supply voltage Vₙ. Because the switching frequency of the modulation is at least the cut-off frequency of the low-pass characteristics present at the gate of the IGBT 81, the modulated voltage is filtered by the low-pass characteristics present in the gate, thus forming a relatively stable gate-emitter voltage V_{GE}. As shown in FIG. 8, the stable gate-emitter voltage V_{GE} after instant t₂ is a DC voltage with a minor ripple. The voltage level v_{mod} of the gate-emitter voltage V_{GE} is below the level Vₚ the gate-emitter voltage V_{GE} had during normal operation.

The above approach for adjusting the control terminal voltage is simple and can have a high dynamic response. This approach improves the controllability of the short circuit current in case of a failure by reducing the gate-emitter voltage limiting the short circuit current.

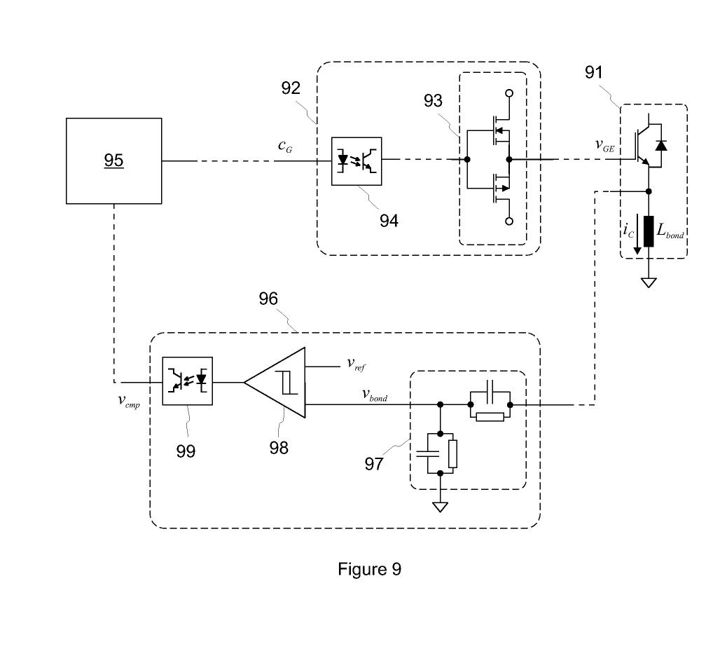

FIG. 9 shows a simplified presentation of an exemplary embodiment of the method of the present disclosure in a frequency converter. A short circuit protection apparatus for one of the IGBTs of the frequency converter is shown in FIG. 9.

The short circuit protection apparatus can include a driver unit 92, a current sensing unit 96, and a controller 95. The current through the IGBT 91 is responsive to the gate-emitter voltage V_{GE} of the switch. The driver unit 92 drives the gate-emitter voltage V_{GE} (i.e. the control terminal voltage). The driver unit 92 can include a push-pull output circuit 93 and a first optocoupler 94. The output voltage of the push-pull output circuit 93 is controlled in response to a control signal c_{G}. A controller 95 provides the control signal c_{G} to the push-pull output circuit 93 through the first optocoupler 94 which provides galvanic isolation between the controller 95 and the push-pull circuit 93. In the example of FIG. 9, the controller 95 is an FPGA controlling also the switching of the IGBTs of the frequency converter during normal operation. The controller 95 can be used for implementing short circuit protection for all IGBTs in the frequency converter. In accordance with an exemplary embodiment, the controller 95 constitutes a means for controlling an on-state voltage level of the control terminal voltage on the basis of the comparison to limit the current through the switch during the detected short circuit, where the on-state voltage level voltage is controlled by pulse-width modulating the output of the driver unit, and a switching frequency of the modulation is at least the cut-off frequency of low-pass characteristics of the control terminal, and a means for controlling the control terminal voltage to an off-state voltage level in order to turn the switch off.

In FIG. 9, the IGBT can have a stray inductance L_{bond} in the path of the collector current i_{C}. The stray inductance L_{bond} is formed by chip bonding. A current sensing unit 96 is configured to measure or estimate the collector current i_{C} by measuring a bond voltage V_{bond} over the stray inductance L_{bond}. The current sensing unit 96 uses a compensated voltage divider 97 to measure the bond voltage V_{bond}. The current sensing unit 96 further can include a comparator 98 and a second optocoupler 99. The comparator 98 is configured to compare the bond voltage V_{bond} with a predetermined limit v_{ref} so that the output v_{cmp} of the comparator 98 shows when the bond voltage V_{bond} exceeds the limit v_{ref}. The comparator 98 output can be in the form of a digital one-bit signal.

The time the bond voltage V_{bond} exceeds the limit v_{ref} is then used for estimating the collector current i_{C}. In FIG. 9, the comparison result v_{cmp} is transmitted to the controller 95 through the second optocoupler 99. The controller 95 compares it with a short circuit current limit in order to determine if a short circuit has occurred.

The controller 95 is configured to control the gate-emitter voltage v_{GE} at the gate of the IGBT 91 on the basis of the detected short circuit. When a short circuit is detected, the controller 95 controls the control signal c_{G} to pulse-width modulate at high frequency. As a result, the output of the push-pull circuit 93 also modulates. The low-pass characteristics present on the gate of the IGBT 91 filter the modulated output signal forming a DC voltage. In this manner, the gate-emitter voltage V_{GE} is reduced to a value over the IGBT threshold voltage. Thus, the collector current is limited during the short circuit and the IGBT 91 starts to desaturate. After a few microseconds (3 μs in the studied cases) or, alternatively, the detection of IGBT desaturation, the IGBT 91 is turned off.

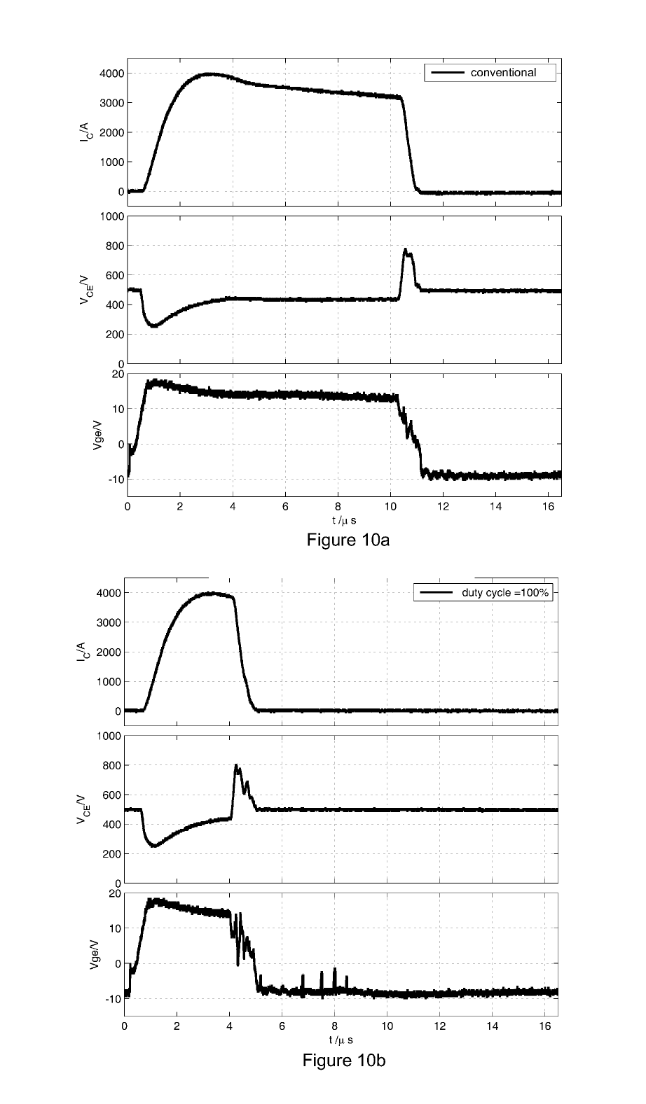

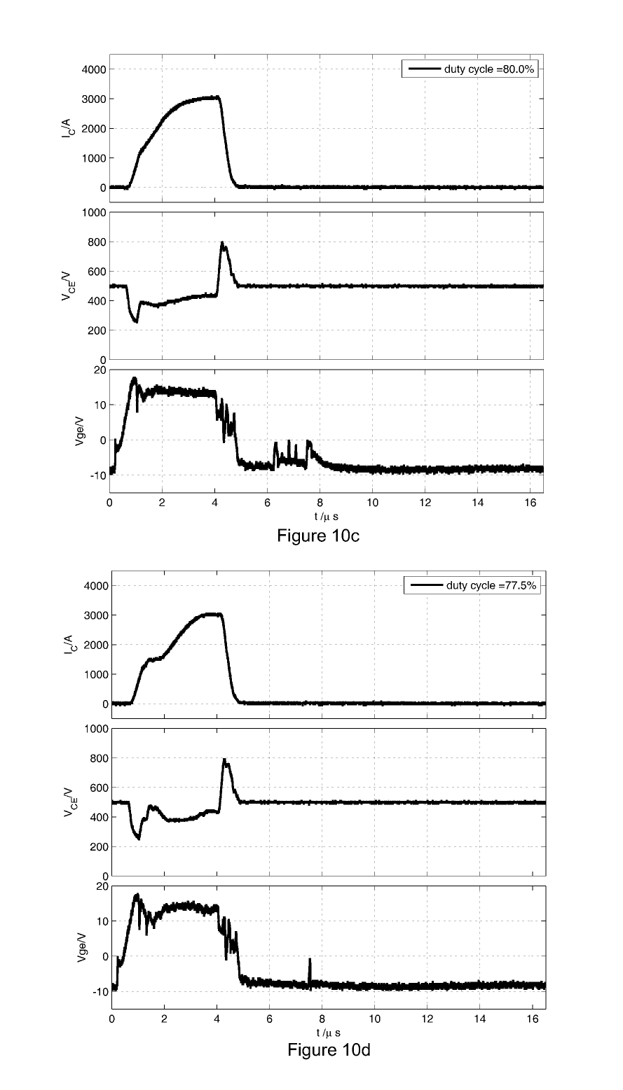

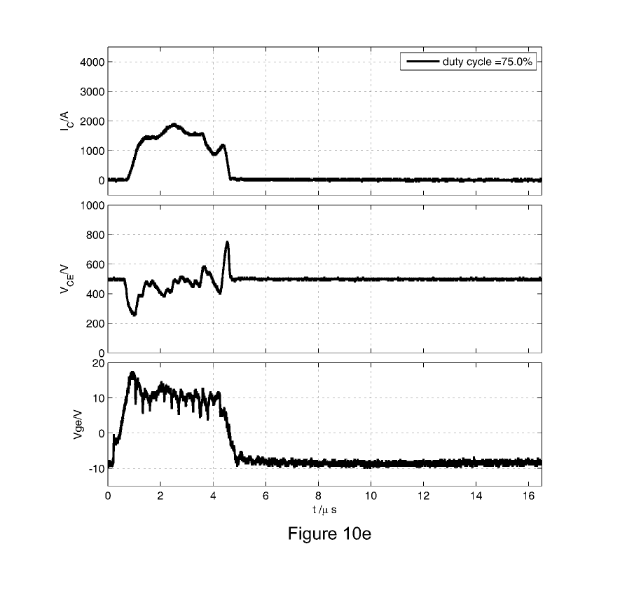

FIGS. 10a to 10e show exemplary test results for the method of the present disclosure. In FIGS. 10a to 10e, the disclosed short circuit current detection and limitation method was compared with a known method using detection by measurement of the collector-emitter saturation voltage (V_{CE,SAT}). The test were performed using an Infineon 1200-V, 1400-A IGBT module FF1400R12IP4. The short circuit detection limit was set to approximately at 1400 A. In the tests, the IGBT was switched to a short circuit, i.e. the detected short circuit was of type I. After detecting a short circuit, the method of the present disclosure reduces the gate-emitter voltage to a set level.

The results of the known method are shown in FIG. 10a. The method of the present disclosure was tested using four different gate-emitter voltage levels, The results at these levels, i.e. at 15 V (100% duty cycle), at 12 V (80% duty cycle), at 11.6 V (77.5% duty cycle), and at 11.3 V (75% duty cycle), are shown in the FIGS. 10b to 10e, respectively. In FIGS. 10a to 10e, the top plots show the collector currents. The middle plots show the respective collector-emitter saturation voltages. The bottom plots show the respective gate-emitter voltages.

FIGS. 10a to 10e show that the method of the present disclosure is able to limit the current to 40% or less compared with the current of the known method. The faster turn-off of the short circuit reduced the amount of energy of the short circuit and consequently the temperature of the semiconductor during the short circuit. Thus, the method of the present disclosure shows a potential for minimising the mechanical damage in case of a failure. Further, the results show that, with the method of the present disclosure, higher gate-emitter voltages can be used during normal operation in order to reduce the on-state losses.

It is obvious to a person skilled in the art that the inventive concept can be implemented in various ways. The present disclosure and its embodiments are not limited to the examples described above but can vary within the scope of the claims. For example, the method of the present disclosure can be implemented completely in the driver unit of the switch. The method of the present disclosure can be applied to various types of semiconductor switches. The current estimation can be calibrated and the short circuit limits can be adapted depending on the semiconductor switch in question.

Capacitive or inductive measurements of voltage over the stray inductance can be used. The voltages can be measured by using an A/D converter or a plurality of A/D converters. Measurements without a conversion to a digital format are also possible.

In the method of the present disclosure, current can be determined also by other means. For example, a Rogowski coil or a shunt resistor can also be used for measuring a current through a switch. The current can also be estimated by integrating the bond voltage. Following Equation 1, the collector current i_{C} can be calculated as the integral of the bond voltage v_{bond}:

$$⇒ \frac{1}{{L}_{bond}} {\int }_{{t}_{1}}^{{t}_{2}} {v}_{bond} d t = {i}_{c} . \qquad ( 2 )$$

On the basis of Equation 2, the current through a switch can be estimated by integrating a bond voltage (or a voltage over other inductance in series with the switch) for a period of time, measuring the integrated voltage, and estimating the current on the basis of the integrated voltage. The voltage can be measured and integrated by using an analog integrator, for example.

Further, even though an FPGA was mentioned as a platform for implementing the controller, other approaches can also be used. For example, the implementation of the steps of the method of the present disclosure can be carried out by analog electronic circuitry. The control can also be implemented on another digital device, such as a DSP (digital signal processor) or a microcontroller of a computer processing device (e.g., CPU), in which the processor (e.g., application specific or general purpose processor) or microcontroller is configured to execute a computer-readable program and/or computer-readable instructions tangibly recorded on a non-transitory computer-readable recording medium (i.e. a non-volatile memory such as a computer ROM, hard disk drive, flash memory, optical memory, etc.) that is resident in the computer processing device in which the processor or microcontroller is provided. The computer processing device is communicatively coupled (e.g., by wired or wireless mediums) to the power semiconductor switch for communicating with the switch and carrying out the operative features of the present disclosure as described herein.

The variation of the gate-emitter voltage can be implemented by varying a supply voltage of the driver unit or by using several power supplies for the driver unit and switching between those.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCES

[1] CT-Concept Technologie AG.; “2SP0320T Description & Application Manual, “http://www.igbt-drivercom/fileadmin/Public/PDF/Products/ENG/SCALE-2/PnP/2SP0320/Manuals/2SP0320T_Manual.pdf”
[2] Volke, A.; Hornkamp, M.; “IGBT Modules Technologies, Driver and Application,” ISBN: 978-3-00-032076-7, Infineon Technologies AG, Munich, 2010.
[3] Gerber, D.; Guillod, T.; Biela, J.; “IGBT gate-drive with PCB Rogowski coil for improved short circuit detection and current turn-off capability,” Pulsed Power Conference (PPC), 2011 IEEE, pp. 1359-1364, 19-23 Jun. 2011
[4] Min-Sub, K.; Byoung-Gun, P.; Rae-Young, K.; Dong-Seok, H.; “A novel fault detection circuit for short-circuit faults of IGBT,” Applied Power Electronics Conference and Exposition (APEC), 2011 Twenty-Sixth Annual IEEE, pp. 359-363, 6-11 Mar. 2011
[5] Belwon, W. A.; Wennerlund, P.; Olin, K.; “An improved overcurrent protection circuit for an IGBT in an inverter.” UK Patent GB 2 458 704 A, Application No 0805739.0, Mar. 29, 2008

What is claimed is:

1. A method for a power semiconductor switch, wherein a current through the switch is responsive to a control terminal voltage at a control terminal of the switch, the control terminal voltage being driven by a driver unit, the method comprising:
measuring or estimating the current;
detecting a short circuit by comparing the measured or estimated current to a short circuit current limit;
controlling an on-state voltage level of the control terminal voltage on the basis of the comparison to limit the current through the switch during the detected short circuit, the on-state voltage level voltage being controlled by pulse-width modulating the output of the driver unit, wherein a switching frequency of the modulation is at least the cut-off frequency of low-pass characteristics of the control terminal; and
controlling the control terminal voltage to an off-state voltage level in order to turn the switch off.

2. A method as claimed in claim 1, wherein the current is estimated on the basis of a bond voltage of the switch.

3. A method as claimed in claim 2, wherein the control terminal voltage is controlled to the off-state voltage level after a predetermined time from a detected short circuit.

4. A method as claimed in claim 2, wherein estimating the current comprises
integrating the bond voltage for a period of time,
measuring the integrated voltage; and
estimating the current on the basis of the integrated voltage.

5. A method as claimed in claim 4, wherein the control terminal voltage is controlled to the off-state voltage level after a predetermined time from a detected short circuit.

6. A method as claimed in claim 2, wherein estimating the current comprises
comparing the bond voltage with a set limit;
measuring a period of time the bond voltage exceeds the set limit; and
estimating the current on the basis of the measured period of time.

7. A method as claimed in claim 6, wherein the control terminal voltage is controlled to the off-state voltage level after a predetermined time from a detected short circuit.

8. A method as claimed in claim 1, wherein the control terminal voltage is controlled to the off-state voltage level after a predetermined time from a detected short circuit.

9. A method as claimed in claim 1, wherein controlling the control terminal voltage to an off-state voltage level comprises:
detecting desaturation of the switch; and
controlling the control terminal voltage to an off-state voltage level after desaturation has been detected.

10. A method as claimed in claim 2, wherein controlling the control terminal voltage to an off-state voltage level comprises:
detecting desaturation of the switch; and
controlling the control terminal voltage to an off-state voltage level after desaturation has been detected.

11. A method as claimed in claim 4, wherein controlling the control terminal voltage to an off-state voltage level comprises:
detecting desaturation of the switch; and
controlling the control terminal voltage to an off-state voltage level after desaturation has been detected.

12. A method as claimed in claim 6, wherein controlling the control terminal voltage to an off-state voltage level comprises:
detecting desaturation of the switch; and
controlling the control terminal voltage to an off-state voltage level after desaturation has been detected.

13. A method as claimed in claim 1, wherein the low-pass characteristics of the control terminal are formed by capacitances present at the gate together with a gate resistance.

14. A method as claimed in claim 13, wherein the gate resistance and an internal gate-emitter capacitance C_{GE} form a low-pass filter.

15. An apparatus for a power semiconductor switch, wherein a current through the switch is responsive to a control terminal voltage at a control terminal of the switch, the control terminal voltage being driven by a driver unit, the apparatus comprising:
means for measuring or estimating the current;
means for detecting a short circuit by comparing the estimated current to a short circuit current limit;
means for controlling an on-state voltage level of the control terminal voltage on the basis of the comparison to limit the current through the switch during the detected short circuit, wherein the means for controlling the on-state voltage are configured to control the on-state voltage level voltage by pulse width modulating the output of the driver unit, a switching frequency of the modulation being at least the cut-off frequency of low-pass characteristics of the control terminal; and
means for controlling the control terminal voltage to an off-state voltage level in order to turn the switch off.

16. An apparatus as claimed in claim 15, wherein the means for measuring or estimating the current comprise means for estimating the current on the basis of a bond voltage of the switch.

17. A frequency converter comprising the apparatus as claimed in claim 15.

18. A frequency converter comprising the apparatus as claimed in claim 17.

19. A non-transitory computer-readable recording medium having a computer program tangibly recorded thereon that, when executed by a processor of a computer processing device, causes the processor to carry out a method for a power semiconductor switch communicatively coupled to the power semiconductor switch, wherein a current through the switch is responsive to a control terminal voltage at a control terminal of the switch, the control terminal voltage being driven by a driver unit, the method comprising:
measuring or estimating the current;
detecting a short circuit by comparing the measured or estimated current to a short circuit current limit;
controlling an on-state voltage level of the control terminal voltage on the basis of the comparison to limit the current through the switch during the detected short circuit, the on-state voltage level voltage being controlled by pulse-width modulating the output of the driver unit, wherein a switching frequency of the modulation is at least the cut-off frequency of low-pass characteristics of the control terminal; and
controlling the control terminal voltage to an off-state voltage level in order to turn the switch off.
